(19) United States
(12) Patent Application Publication
(10) Pub. No.: US 2014/0362285 A1
(43) Pub. Date: Dec. 11, 2014

(54) LENS MODULE AND METHOD FOR MANUFACTURING LENS MODULE

(71) Applicant: SAMSUNG ELECTRO-MECHANICS CO., LTD., SUWON (KR)

(72) Inventors: Sung Won Min, SUWON-SI (KR); DONG KYUN LEE, SUWON-SI (KR); WOON KI KIM, SUWON-SI (KR); SEOG JIN HONG, SUWON-SI (KR); Ick Chan Shim, SUWON-SI (KR)

(73) Assignee: SAMSUNG ELECTRO-MECHANICS CO., LTD., SUWON (KR)

(21) Appl. No.: 14/109,710

(22) Filed: Dec. 17, 2013

(30) Foreign Application Priority Data
Jun. 5, 2013 (KR) 10-2013-0064665

(51) Int. Cl. G02B 7/00; H04N 5/225

(52) U.S. Cl. CPC G02B 7/005; H04N 5/2253
USPC 348/374; 359/822; 29/464

(57) ABSTRACT

A lens module includes a housing; a lens barrel mounted in the housing; and an actuator unit including an actuator to move the lens barrel. The actuator unit has a coupling area on one end for coupling to the housing, and an adjustment portion on another end for adjusting a tilt of the lens barrel formed.

### CROSS-REFERENCE TO RELATED APPLICATIONS

This application claims the priority of Korean Patent Application No. 10-2013-0064665 filed on Jun. 5, 2013, in the Korean Intellectual Property Office, the disclosure of which is incorporated in its entirety herein by reference.

### BACKGROUND

1. Technical Field

The present technology generally relates to a lens module and a method for manufacturing a lens module, and more particularly, to a lens module capable of actively aligning a tilt of a lens barrel with respect to the optical axis, and a method for manufacturing a lens module.

2. Description of the Related Art

Unless otherwise indicated herein, the materials described in this section are not prior art to the claims herein and are not admitted to be prior art by inclusion in this section.

As the resolution of camera devices continues to increase, the performance of such camera devices is likely to deteriorate due to minute dimensional errors. For example, a tilt of a lens barrel may cause distortion or the like in an image imaged on an image sensor.

Accordingly, the “active alignment”, which adjusts the optical axis of a lens barrel so that it is orthogonal with respect to the image plane of an image sensor even after the lens barrel has been mounted in the housing, is of interest. As art to consider, there are provided Patent Documents 1 and 2.

### RELATED ART DOCUMENTS

### (Patent Document 1) Korean Patent Laid-Open Publication No. 2009-0047307

### (Patent Document 2) Korean Patent Laid-Open Publication No. 2012-0088794

### SUMMARY

Some of the embodiments herein provide a lens module capable of affecting the resolution and quality of an image captured by an image sensor by actively aligning a tilt of a lens barrel relative to an optical axis.

According to some embodiments herein, a lens module may comprise a housing; a lens barrel mounted in the housing; and an actuator unit including an actuator to move the lens barrel, wherein the actuator unit has a coupling portion on one end for coupling to the housing, and an adjustment portion on another end for adjusting a tilt of the lens barrel.

The adjustment portion may comprise a groove formed in another end of the actuator unit.

The actuator unit may have a hole formed in another end, and an adhesive for bonding the actuator unit and the housing may be injected through the hole.

The lens module may further include a affixation member for fixing another end of the actuator unit to the housing.

The actuator unit may have one or more holes formed in the other end, and the housing may have one or more protrusions having a size smaller than that of the holes.

The actuator may include: a rod member; a piezoelectric member coupled to the rod member and configured to generate vibration; and a mass member coupled to the piezoelectric member and having a predetermined mass.

The rod member may be in contact with a magnetic material mounted on the lens barrel.

The actuator unit may include a bracket accommodating the actuator. The actuator may include a rod member in contact with the lens barrel, a piezoelectric member coupled to the rod member and configured to generate vibration, and a mass member coupled to the piezoelectric member and having a predetermined mass.

One or more adjustment holes through which the adjustment portion is exposed to an outside of the housing may be formed in one surface or in plural of side surfaces of the housing.

The coupling portion may have a protrusion extending in an optical axis direction of the lens barrel, and the housing may have a coupling portion in which the protrusion is fitted.

The coupling portion may have a protrusion member extending in an optical axis direction of the lens barrel, and a cross-section of the protrusion member may be hemispherical, pyramidal or conical in shape.

The coupling portion and the adjustment portion may be arranged in a collinear manner.

According to some embodiments herein, a lens module may comprise a housing; an image sensor unit installed in the housing; a lens barrel installed in the housing; and an actuator unit including an actuator to move the lens barrel, wherein a coupling portion for coupling to the image sensor unit is formed on one end of the actuator unit, and an adjustment portion for adjusting a tilt of the lens barrel is formed on another end of the actuator unit.

The actuator may include: a rod member; a piezoelectric member coupled to the rod member and configured to generate vibration; and a mass member coupled to the piezoelectric member and having a predetermined mass.

The rod member may be in contact with a magnetic material mounted on the lens barrel.

The actuator unit may include a bracket for accommodating the actuator. The actuator may comprise a piezoelectric member.

The coupling portion may comprise a protrusion member extending in an optical axis direction of the lens barrel, and the image sensor unit may have a coupling portion in which the protrusion member is fitted.

The coupling portion and the adjustment portion may be arranged in a collinear manner.

According to some embodiments herein, a lens module may include a housing; a lens barrel installed in the housing; and an actuator unit including an actuator to move the lens barrel, one end of the actuator unit being fixed to the housing. The housing may have an alignment hole through which a part of the actuator unit or the lens barrel is exposed so that a tilt of the actuator unit or the lens barrel can be adjusted.

According to some embodiments herein, a lens module may comprise a housing; a lens barrel installed in the housing; an actuator unit including an actuator to move the lens barrel, one end of the actuator unit being fixed to the housing; and a fixing unit for fixing the actuator unit to the housing with a tilt of the lens barrel adjusted.

The affixation unit may comprise an adhesive or a bolt.

The housing may have one or more holes on one surface or side surfaces for mounting the affixation unit.

The actuator may include a piezoelectric member.

The affixation unit may be coupled to another end of the actuator unit.

According to some embodiments herein, a lens module may include an image sensor unit having an image sensor; a housing including a lens barrel and an actuator configured to move the lens barrel, wherein a coupling portion for coupling to the image sensor unit is formed on one end of the housing, and an adjustment portion for adjusting a slope of the housing relative to the image sensor is formed on the other end of the housing; and a fixing unit couples the image sensor unit to the housing, with the slope of the housing relative to the image sensor adjusted.

According to some embodiments herein, a method of manufacturing a lens module may include fixing one end of an actuator unit coupled to a lens barrel to a housing; performing active alignment of the lens barrel by moving another end of the actuator in an orthogonal direction to an optical direction of the lens barrel; and fixing another end of the actuator to the housing.

Performing active alignment may comprise adjusting the tilt of the lens barrel by moving another end of the actuator unit with the housing fixed.

The fixing of another end of the actuator to the housing may include injecting an adhesive into a contact portion between another end of the actuator and the housing.

The fixing of another end of the actuator to the housing may include coupling another end of the actuator unit with the housing by using a coupler.

Performing active alignment of the lens barrel may include fixing the housing to a first jig; and moving the another end of the actuator to a second jig which is movable relative to the first jig.

In accordance with some embodiments, an apparatus for adjusting a tilt of a lens barrel may comprise an actuator configured to move a lens barrel assembled in a housing. The actuator may comprise a coupling area coupled to the housing; and a movable portion for adjusting a tilt of the assembled lens barrel. The coupling area may be formed on one end of the actuator, and the movable portion may be formed on another end of the actuator. The movable portion is at least movable in a direction orthogonal to an optical axis of the lens barrel.

The apparatus may further comprise a fixer to fix the movable portion to the housing after adjusting the tilt of the assembled lens barrel.

The actuator may have one or more holes for inserting the fixer therethrough.

The movable portion may have a portion with a shape for coupling with a tool for carrying out active alignment of the tilt of the assembled lens barrel.

The coupling area may have a hole or protrusion to couple with the housing.

The actuator may further comprise a rod shaped member for interacting with a magnetic material mounted on the lens barrel.

The housing may comprise one or more holes to expose the movable portion of the actuator to the outside of the housing.

The coupling area of the actuator may be fixed to the housing so that the lens barrel does not contact the housing.

The actuator may be mounted near an edge of the housing.

The tilt of the lens barrel may be adjusted to align an optical axis of the lens barrel with an optical axis of an image sensor.

The actuator may comprise a vibrator configured to generate a force to move the lens barrel.

In accordance with some embodiments, an apparatus for adjusting a tilt of lens barrel may comprise an actuator configured to move a lens barrel assembled in a housing. The actuator may comprise a coupling area coupled to an image sensing unit comprising an image sensor; and a movable portion for adjusting a tilt of the assembled lens barrel. The coupling area may be formed on one end of the actuator, and the movable portion may be formed on another end of the actuator. The movable portion is movable in a direction orthogonal to an optical axis of the lens barrel.

The apparatus may further comprise a fixer to fix the movable portion to the housing after adjusting the tilt of the assembled lens barrel.

The coupling area may have a hole or protrusion to couple it with the image sensing unit.

The tilt of the lens barrel may be adjusted to align an optical axis of the lens barrel with an optical axis of the image sensor.

The movable portion may have a portion with a shape for coupling with a tool for carrying out active alignment of the tilt of the assembled lens barrel.

The housing may comprise one or more holes to expose the movable portion to the outside of the housing.

In accordance with some embodiments, a method for manufacturing a lens module may comprises assembling a lens module comprising a housing, a lens barrel and an actuator coupled to the lens barrel; moving an movable portion of the actuator to adjust a tilt of the assembled lens barrel after assembling the lens module; and fixing the movable portion of the actuator to the housing.

The assembling the lens module may comprise fixing one end of the actuator to the housing. The assembling the lens module may comprise fixing one end of the actuator to an image sensing unit comprising an image sensor.

The moving the movable portion of the actuator may comprise aligning an optical axis of the lens barrel with an optical axis of an image sensor. The moving the movable portion of the actuator may comprise coupling the movable portion of the actuator with a tool for carrying out active alignment of the tilt of the assembled lens barrel.

### BRIEF DESCRIPTION OF THE DRAWINGS

Embodiments of the present invention will be more clearly understood from the following description taken in conjunction with the accompanying drawings, in which:

FIG. 1 is an exploded perspective view of a lens module according to an embodiment;

FIG. 2 is an exploded perspective view showing an actuator unit and a lens barrel shown in FIG. 1 separated from each other;

FIG. 3 is an exploded perspective view of the actuator unit shown in FIG. 2;

FIG. 4 is an assembled perspective view showing the actuator unit shown in FIG. 3;

FIG. 5 is a view showing that the lens barrel shown in FIG. 2 and the rod member shown in FIG. 3 are coupled;

FIG. 6 is a top perspective view showing the lens barrel (including the actuator unit) shown in FIG. 1;

FIG. 7 is a bottom perspective view of the lens barrel (including the actuator unit) shown in FIG. 1;

FIG. 8 is a bottom perspective view of the housing shown in FIG. 1;

FIG. 9 is a perspective view of the assembled lens module shown in FIG. 1;

FIG. 10 is a view of the lens module shown in FIG. 9 with the housing removed therefrom;

FIGS. 11, 12A and 12B are views illustrating the principle of adjusting the tilt of the lens barrel in the lens module shown in FIG. 9;

FIG. 13 is a perspective view of the lens module shown in FIG. 9 with a shield can;

FIG. 14 is an exploded perspective view of a lens module according to another embodiment; and

FIG. 15 is a conceptual view illustrating the principle of active alignment of the lens module shown in FIG. 14.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided to explain the principles of the invention and its practical applications, thereby enabling others skilled in the art to understand the invention for various embodiments and with various modifications as are suited to the particular use contemplated. In the drawings, the shapes and dimensions of elements may be exaggerated for clarity, and the same reference numerals will be used throughout to designate the same or like elements. It will also be understood that, although the terms first, second, etc. may be used herein to describe various elements, these elements should not be limited by these terms. These terms are only used to distinguish one element from another. As used in this description and the appended claims, the singular forms “a”, “an” and “the” are intended to include the plural forms as well, unless the context clearly indicates otherwise.

In the following descriptions of the embodiments, terms referring to elements are named in consideration of the functions of the elements. The terms should not be construed as limiting.

In the detailed description, the term “active alignment” generally refers to general operations for aligning the tilt or optical axis of a lens barrel with the optical axis of an image sensor. The term “alignment direction” may refer to all directions on a plane generally orthogonal to the optical axis of a lens barrel or the optical axis of an image sensor.

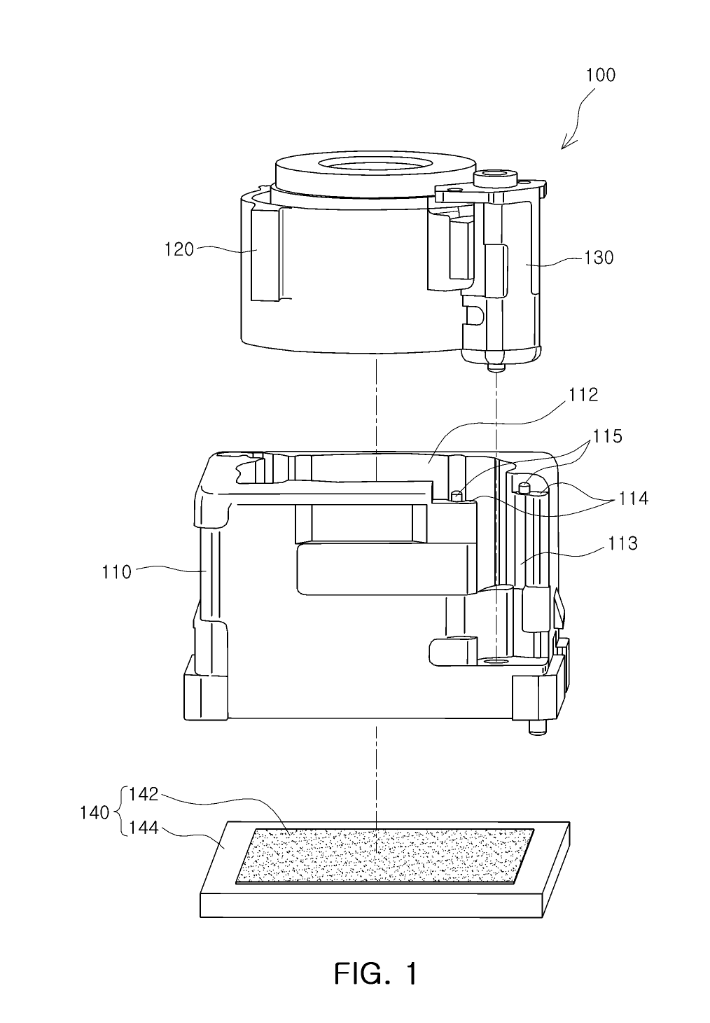

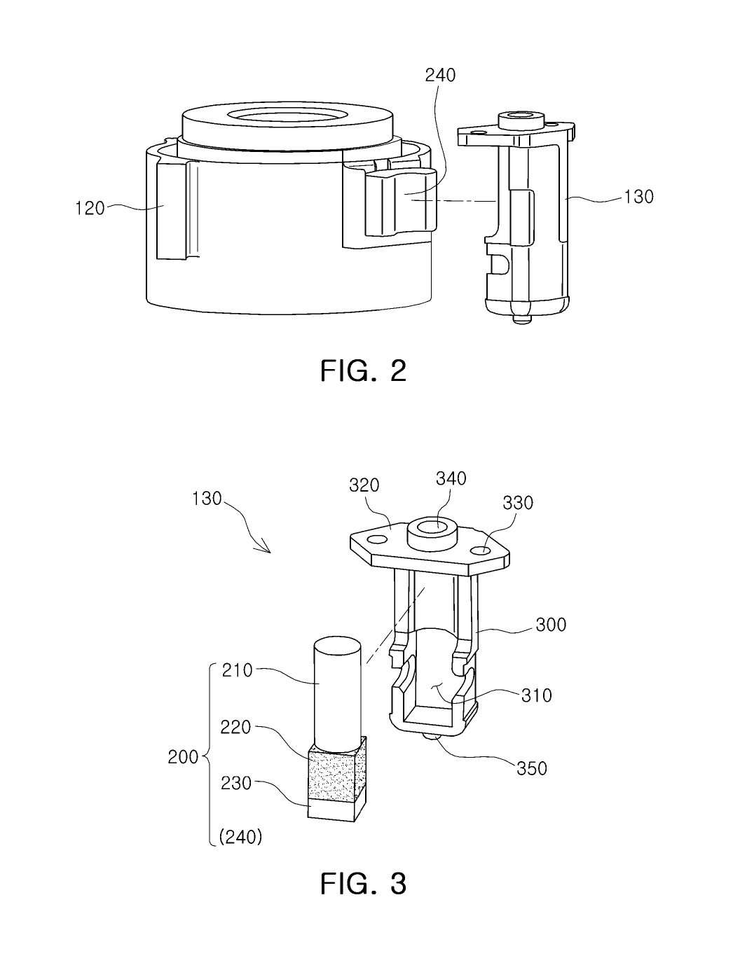

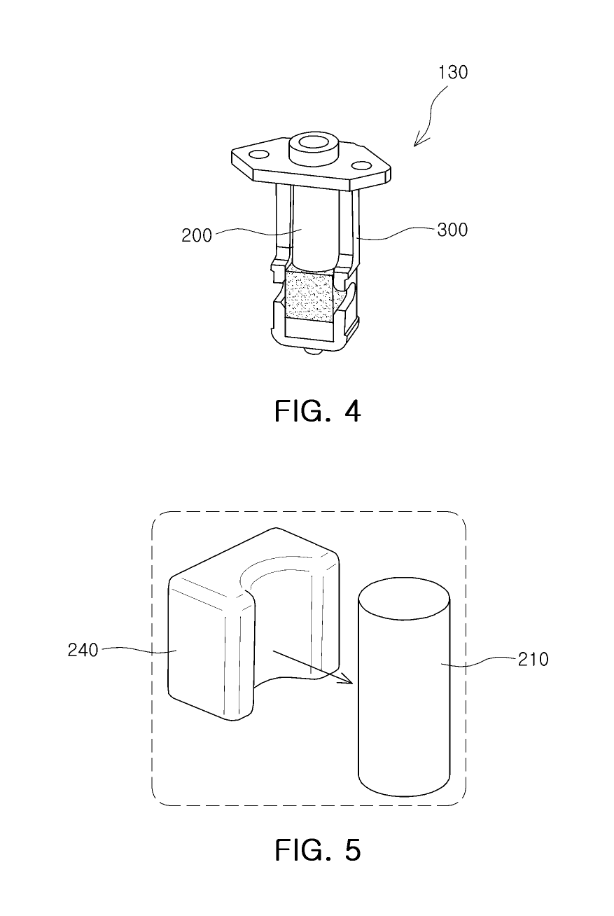

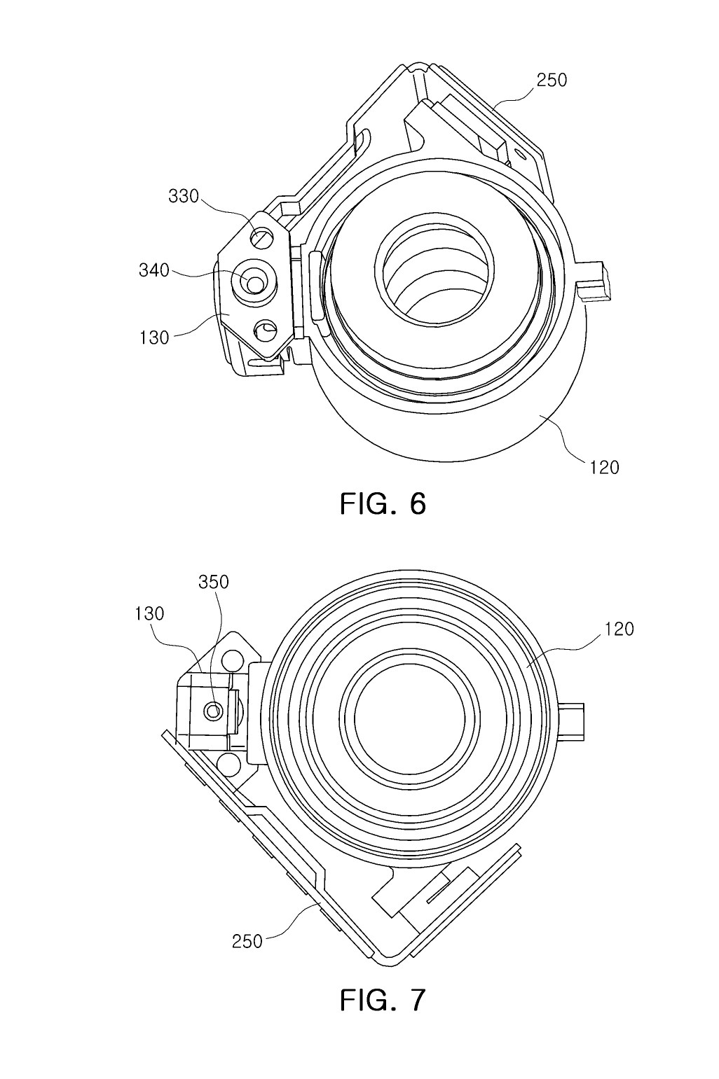

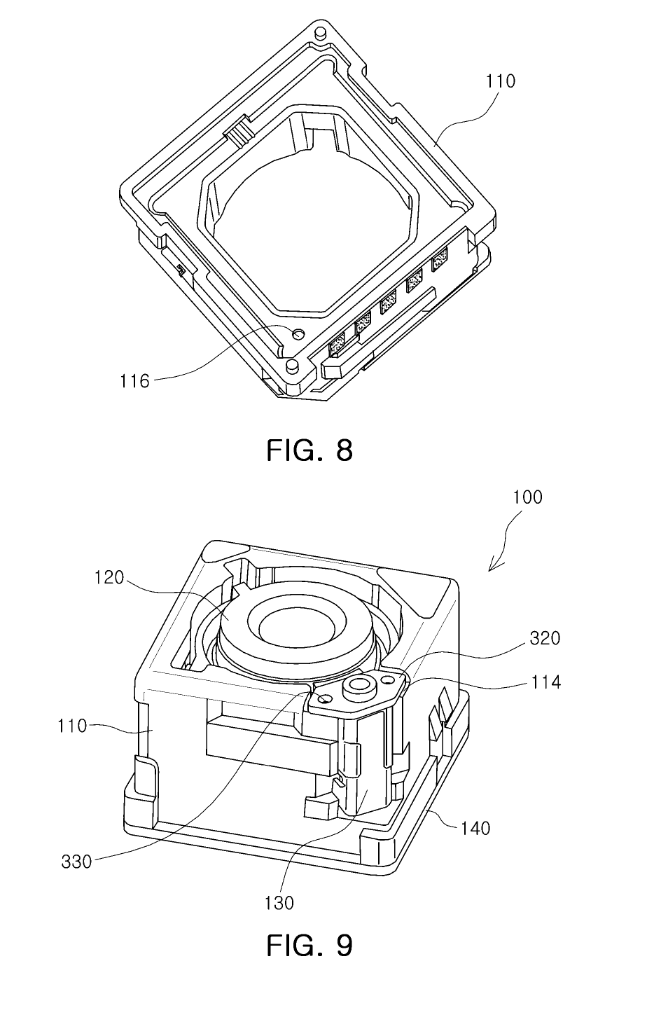

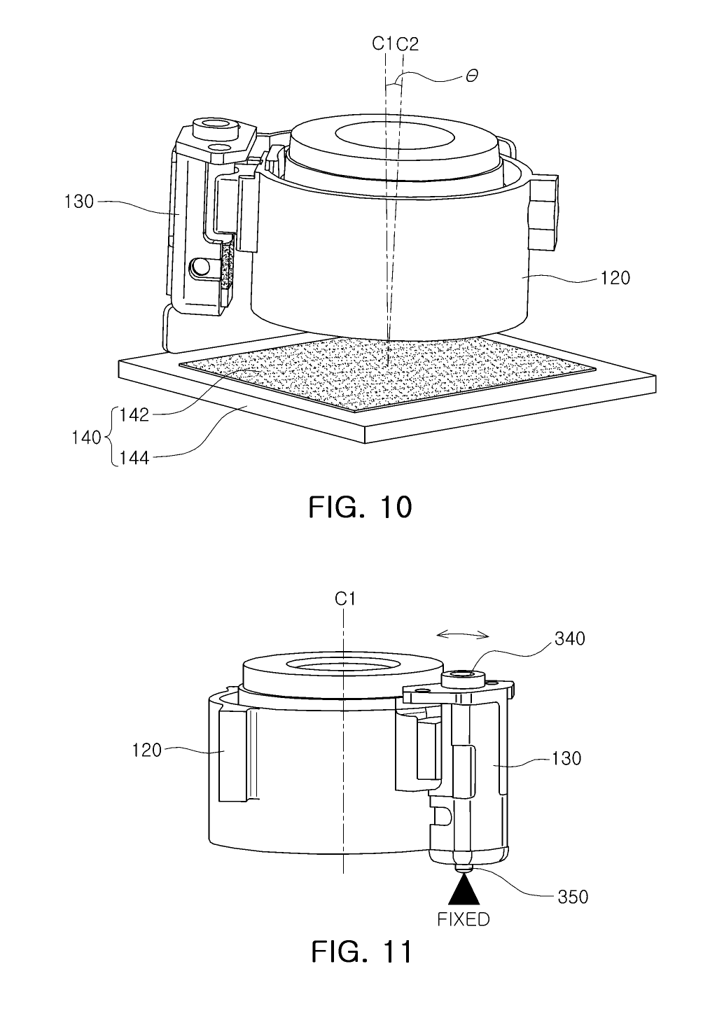

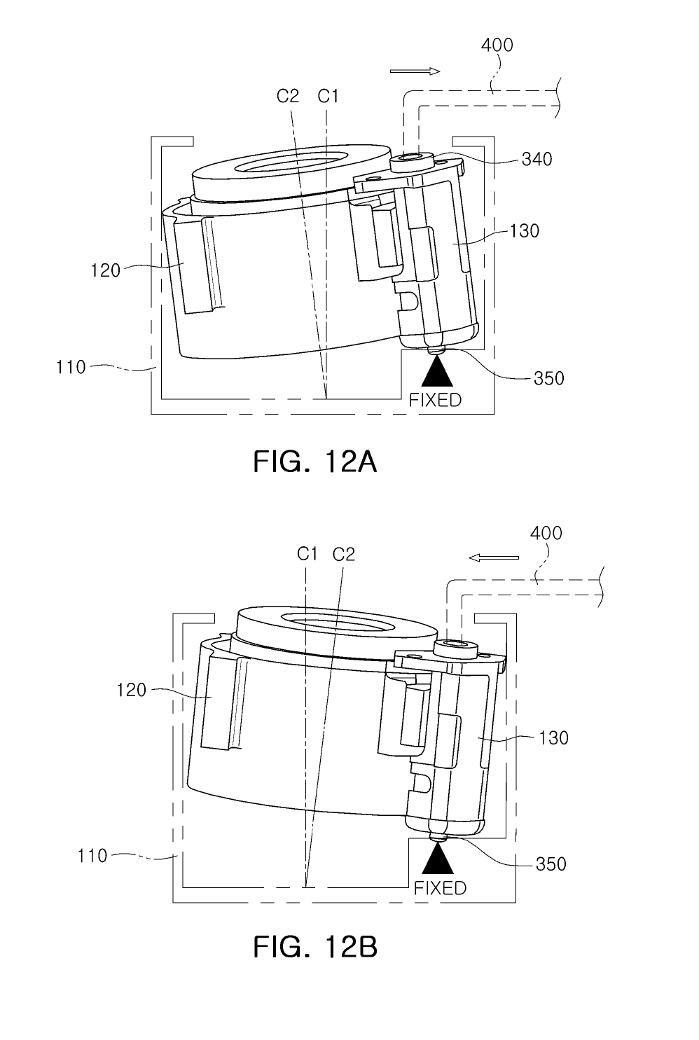

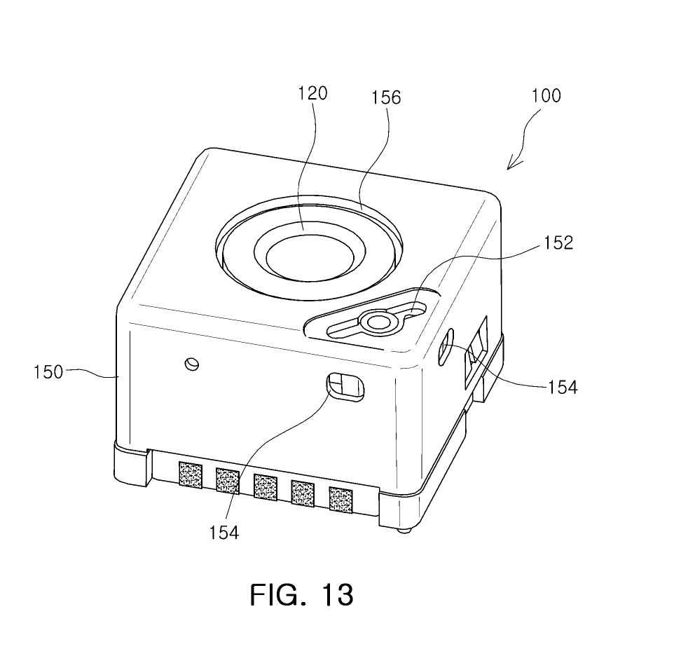

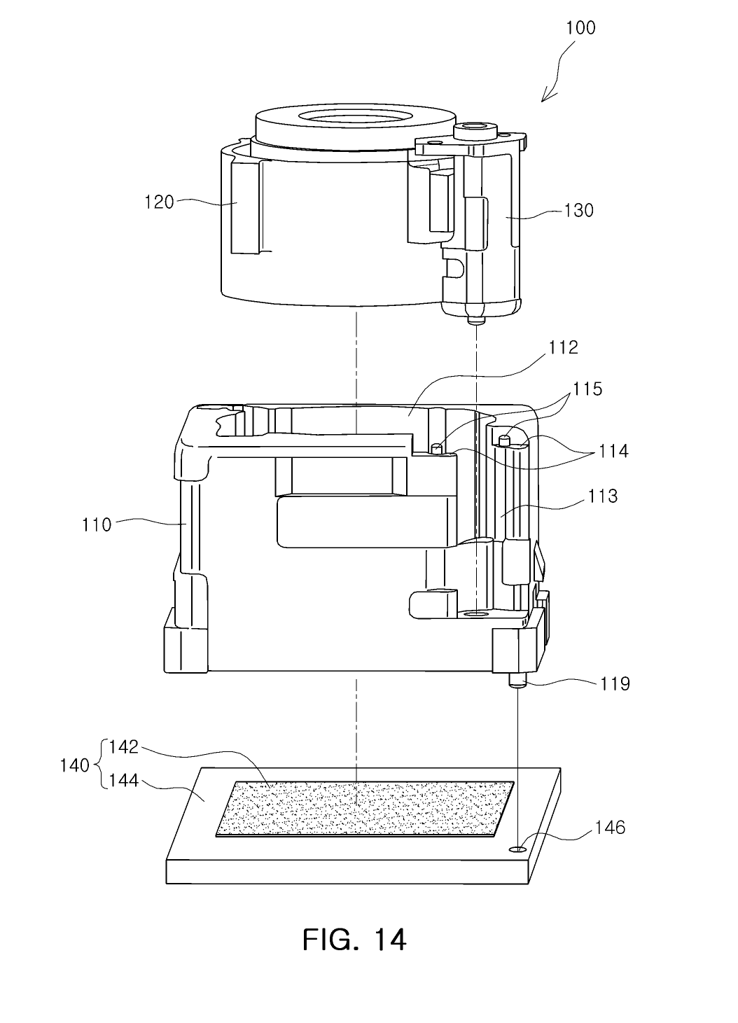

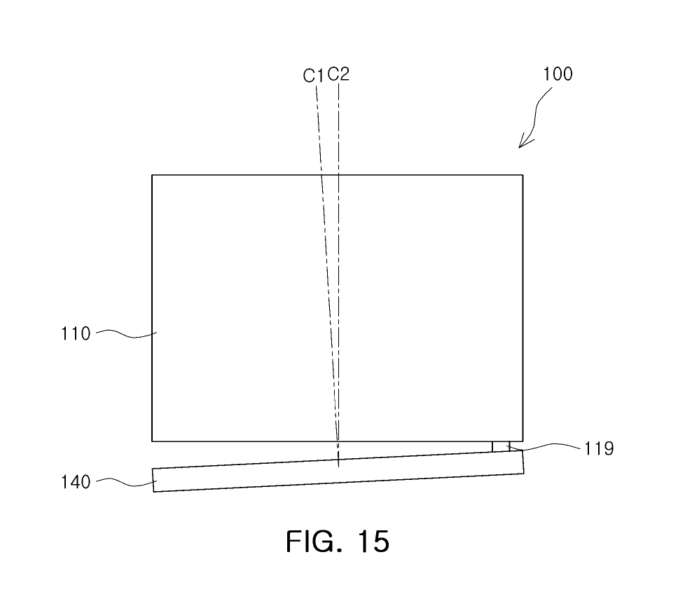

FIG. 1 is an exploded perspective view of a lens module according to an embodiment; FIG. 2 is a exploded perspective view showing an actuator unit and a lens barrel shown in FIG. 1 separated from each other; FIG. 3 is an exploded perspective view of the actuator unit shown in FIG. 2; FIG. 4 is an assembled perspective view showing the actuator unit shown in FIG. 3; FIG. 5 is a view showing that the lens barrel shown in FIG. 2 and the rod member shown in FIG. 3 are coupled; FIG. 6 is a top perspective view showing the lens barrel (including the actuator unit) shown in FIG. 1; FIG. 7 is a bottom perspective view of the lens barrel (including the actuator unit) shown in FIG. 1; FIG. 8 is a bottom perspective view of the housing shown in FIG. 1; FIG. 9 is a perspective view of the assembled lens module shown in FIG. 1; FIG. 10 is a view of the lens module shown in FIG. 9 with the housing removed; FIGS. 11, 12A and 12B are conceptual views illustrating the principle of adjusting the tilt of the lens barrel in the lens module shown in FIG. 9; FIG. 13 is a perspective view of the lens module shown in FIG. 9 with a shield can; FIG. 14 is an exploded perspective view of a lens module according to another embodiment; and FIG. 15 is a conceptual view illustrating the principle of active alignment of the lens module shown in FIG. 14.

A lens module 100 according to an embodiment of the present invention may include a housing 110, a lens barrel 120, and an actuator unit 130, as shown in FIG. 1. The lens module 100 may further include an image sensor unit 140. Additionally, the lens module 100 may include a shield can 150 as shown in FIG. 13. However, the lens module 100 does not exclude but may include additional elements as necessary. For example, the lens module 100 may further include a sensor for sensing a position of the lens barrel 120 relative to the image sensor unit 140, such as a hall sensor.

The housing 110 may accommodate the lens barrel 120 and the actuator unit 130. By way of example and not limitation, the housing 110 may have a first accommodating portion 112 to accommodate the lens barrel 120, and a second accommodating portion 113 to accommodate the actuator unit 130. The first accommodating portion 112 may be generally formed in the center of the housing 110, and the second accommodating portion 113 may be formed at an edge near the first accommodating portion 112. For example, as shown in FIG. 1, the second accommodating portion 113 may be formed at an edge of the housing 110, a part of which may be opened toward the side surface of the housing 110.

The first accommodating portion 112 may have a space, such as a cross-sectional area, larger than the lens barrel 120. For instance, the first accommodating portion 112 may have a cross-sectional area larger than that of the lens barrel 120 such that the lens barrel 120 accommodated in the first accommodating portion 112 may move in a vertical direction of the optical axis (hereinafter referred to as the “alignment direction”) for active alignment. Likewise, the second accommodating portion 113 may have a space, such as a cross-sectional area, larger than the actuator unit 130 such that the actuator unit 130 accommodated in the second accommodating portion 113 may move in the direction of alignment. The second accommodating portion 113 may have one or more steps 114 on the left and/or right side surfaces. Furthermore, one or more protrusions 115 extending in a direction, for example, the optical direction, may be formed on the steps 114.

The housing 110 may be made of a material that is tolerant to external impacts. For example, but not limited to, the housing 110 may be formed of metal, plastic or other material having a certain degree of rigidity. The material of the housing 110 may also be formed of other materials as necessary.

The lens barrel 120 may include one or more lenses. Specifically, the lens barrel 120 may include lenses for projecting light reflected from a subject onto the image sensor unit 140. The optical properties of a lens may be determined depending on the type of lens module 100. For instance, a high-resolution lens module 100 may include four or more lenses, and a low-resolution lens module 100 may include three or less lenses. The lens barrel 120 may further include, for example, but not limited to, a stop (not shown) for adjusting an amount of incident light, and/or a filter (not shown) for blocking infrared light.

The inner surface of the lens barrel 120 may be coated with anti-reflection material or light-shielding material. By doing so, light unnecessarily reflected on the inner surface of the lens barrel 120 and made incident on the image sensor unit 140 may be lessened, thereby improving the resolution of the lens module 100.

The actuator unit 130 may be coupled to the lens barrel 120 to move the lens barrel 120. The actuator unit 130 may move the lens barrel 120 in the direction of the optical axis, to change the distance between the lens barrel 120 and the image sensor unit 140. To this end, the actuator unit 130 may include an actuator 200 for moving the lens barrel 120.

The image sensor unit 140 may include an image sensor 142 and a substrate 144. The image sensor unit 140 may further include one or more electronic components, e.g. passive elements, necessary for driving the image sensor 142. The image sensor 142 may be, for example, a CCD (Charge Coupled Device) or CMOS (Complementary Metal Oxide Semiconductor) type electronic component. However, the image sensor 142 is not limited thereto, but may be other types of electronic components as necessary. The substrate 144 may include a circuit pattern for electrical connections between the image sensor 142 and passive elements. In addition to passive elements, the substrate 144 may further include other electronic components for facilitating the operation of the image sensor 142. The image sensor 142 and passive elements may be integrally formed on the substrate 144. For example, the image sensor 142 and passive elements may be manufactured as a chip scale package (CSP).

In the following, the configuration of the actuator unit 130 will be described in detail with reference to FIGS. 2 to 5.

As shown in FIGS. 2 and 3, the actuator unit 130 may include an actuator 200 and a bracket 300. The actuator 200 is configured to move the lens barrel 120, and the bracket 300 is for accommodating and supporting the actuator 200.

The actuator 200 may include a rod member 210, a piezoelectric member 220, a mass member 230, and a magnetic member 240.

The rod member 210 may have a generally cylindrical shape. However, the shape of the rod member 210 is not limited thereto. The rod member 210 may have different shapes as long as it delivers the vibrations of the piezoelectric member 220 to the lens barrel 120 or the magnetic member 240. For example, the rod member 210 may be formed as a prism. The rod member 210 may be in contact with the magnetic member 240, as shown in FIG. 5. Specifically, the rod member 210 may be in close contact with the magnetic member 240 by magnetic force. The rod member 210 may be formed of, for example, but not limited to, a ferromagnetic material which is easily subjected to magnetic force. However, the material of the rod member 210 may be formed of other materials as necessary, for example, a non-ferromagnetic material.

The piezoelectric member 220 may be attached to one end of the rod member 210, and may provide substantial driving force enabling the movement of the lens barrel 120. By way of example and not limitation, the piezoelectric member 220 may vibrate the rod member 210 in the longitudinal direction by repeating movements of expansion and/or contraction according to a current signal, and the vibration of the rod member 210 may move the lens barrel 120 in the optical direction. Here, the direction of movement of the lens barrel 120 may vary depending on the movement pattern of the piezoelectric member 220 vibrating the rod member 210.

The mass member 230 may be formed at one end of the piezoelectric member 220. For example, the mass member 230 may be positioned on the side of the piezoelectric member 220 other than the side on which the rod member 210 is positioned. The mass member 230 thus formed, may contribute to directivity and stability of the driving force of the piezoelectric member 220.

The magnetic member 240 may be coupled to the lens barrel 120. In an exemplary embodiment, the magnetic member 240 may be firmly attached on the side surface of the lens barrel 120. The magnetic member 240 thus configured may enhance contact between the lens barrel 120 and the actuator 200, to deliver a driving force from the actuator 200 to the lens barrel 120. In this regard, on one surface of the magnetic member 240, a groove may be formed with which the cylindrical rod member 210 may be in close contact.

The bracket 300 may accommodate the actuator 200 therein. To that end, the bracket 300 may have an accommodating portion 310 having a space substantially same as or similar to the size of the actuator 200. As shown in FIG. 4, the actuator 200 may be mounted in the accommodating portion 310 such that at least a part of the actuator 200 is exposed.

The bracket 300 may support the lens barrel 120. Specifically, the bracket 300 may support the lens barrel 120 such that the lens barrel 120 is not in contact with the wall surface of the first accommodating portion 112. Accordingly, by adjusting the position of the bracket 300, the mounting position of the lens barrel 120 relative to the housing 110 may be changed.

As shown in FIG. 3, the bracket 300 may have a flange portion 320 and a protrusion member 350.

The protrusion member 350 may be formed on one end of the bracket 300, and may be fixed to the housing 110. For example, but not limited to, the protrusion member 350 may be fitted into a coupling portion 116 (see FIG. 8) of the housing 110, to limit the movement of one end of the bracket 300. The protrusion member 350 may have a pin shape fitted into the bottom of the housing 110. The end portion of the protrusion member 350 may have a hemispherical, pyramidal or conical shape. Further, the protrusion member 350 may be formed of a material having certain elasticity. For example, the protrusion member 350 may have elasticity such that it flexes to a certain degree while being fixed to the housing 110. The protrusion member 350 having such shapes and physical properties may further facilitate the active alignment of the lens barrel 120.

The flange portion 320 may be formed on the other end of the bracket 300. Specifically, the flange portion 320 may extend in the alignment direction from the other end of the bracket 300. The flange portion 320 may not be fixed to the housing 110. That is, the flange portion 320 may be partially in contact with the steps 114 of the housing 110, or may not be in contact with the steps 114. Accordingly, the flange portion 320 may move on the steps 114 of the housing 110 in a slidable manner, when the other end of the bracket 300 is moved.

As shown in FIG. 3, on the other end of the bracket 300, one or more holes 330 and an adjustment portion 340 may be further formed.

The holes 330 may be formed in the flange 320. The holes 330 may be used for spaces in which fixing means such as adhesive or bolts are inserted or fastened in a process of coupling the housing 110 to the actuator unit 130. The protrusions 115 of the housing 110 may be fitted into the holes 330. The diameter of the holes 330 may be greater than that of the protrusions 115. Accordingly, the flanges 320 may move in the direction of alignment even with the protrusions 115 fitted into the holes 330. The holes 330 and protrusion 115 thus configured may prevent the other end of the bracket 300 (i.e., the flange 320) from separating from the housing 110, and may limit the range of movement of the other end of the bracket 300 according to the size of the holes 330.

The adjustment portion 340 may be formed on the other end of the bracket 300. Byway of example and not limitation, the adjustment portion 340 may be formed in a position vertically corresponding to the protrusion member 350. That is, the adjustment portion 340 and the protrusion member 350 may be on the same vertical axis. The adjustment portion 340 may have a groove shape in which a jig for carrying out the active alignment is fitted. However, the shape of the adjustment portion 340 is not limited thereto, but may have a protrusion shape or other shapes as necessary.

The bracket 300 thus configured, may enable the active alignment of the lens barrel 120. The other end of the bracket 300 may move in the direction of alignment as described above so as to adjust the tilt of the lens barrel 120, such that the optical axis C2 of the lens barrel 120 and the optical axis C1 of the image sensor 142 may be aligned.

Although in this embodiment one end of the bracket 300 is fixed to the housing 110, the active alignment of the lens barrel 120 may be carried out by fixing one end of the bracket 300 to the image sensor unit 140 and moving the other end of the bracket 300, as necessary.

In the following, the lens barrel 120 coupled to the actuator unit 130 will be described in detail with reference to FIG. 6.

The actuator unit 130 may be coupled to the lens barrel 120 as described above. For example, but not limited to, the actuator unit 130 may be coupled on the side surface of the lens barrel 120 to move the lens barrel 120 in a direction, e.g. the optical direction C2 of the lens barrel. The actuator unit 130 may include a flexible substrate 250. The flexible substrate 250 may be connected to the piezoelectric member 220 of the actuator 200 to transmit a current signal to the piezoelectric member 220. Further, the flexible substrate 250 may include a hall sensor that senses the location of the lens barrel 120 as it moves.

In the following, the lens barrel 120 and the actuator unit 130 coupled to the housing 110 will be described with reference to FIGS. 7 to 9.

The lens barrel 120 and the actuator unit 130 may be mounted in the housing 110 as shown in FIG. 9. In the exemplary embodiment, the lens barrel 120 may be disposed in the housing 110 without contacting the housing 110, and the actuator unit 130 may be disposed in the housing 110 while being partially fixed to the housing 110. That is, one end of the actuator unit 130 may be fixed to the housing 110, but the other end may not. For instance, one end of the actuator unit 130 may be fixed by coupling of the protrusion member 350 with the coupling portion 116. On the contrary, the other end of the actuator unit 130 may not be in contact with the step 114 of the housing 110, such that it may move in the direction of alignment. However, the movement of the other end of the actuator unit 130 may be limited to a certain range of movements by coupling of the holes 330 with protrusions 115.

In the following, the principle of the active alignment of the lens barrel 120 using the actuator unit 130 will be described with reference to FIGS. 10 to 12.

The lens barrel 120 may project a ray reflected from a subject onto the image sensor 142. The image sensor 142 may convert the feature of the subject into image information by using the incident light through the lens barrel 120. Therefore, it is preferable for implementing a clear image of a subject to align the optical axis C1 of the image sensor 142 with the optical axis C2 of the lens barrel 120. However, the coupling position of the lens barrel 120 is likely to be changed when the lens barrel 120 is mounted in the housing 110. The optical axis C1 of the image sensor 142 may be tilted with respect to the optical axis C2 of the lens barrel 120 at a certain degree θ as shown in FIG. 10, which is difficult to accommodate at the time of assembling the lens barrel 120.

In the lens module 100 according to an embodiment, such a drawback may be overcome by way of the active alignment of the lens barrel 120. That is, in the lens module 100 according to the embodiment, as shown in FIG. 11, one end of the actuator unit 130, e.g. the protrusion member 350, is fixed, but the other end of the actuator unit 130, e.g. the adjustment portion 340, is not fixed. Accordingly, if the optical axis C2 of the lens barrel 120 is inclined with respect to the optical axis C1 of the image sensor 142, the other end 340 of the actuator unit 130 may be moved in the alignment direction so that the optical axes C1 and C2 are aligned.

For example, if the optical axis C2 of the lens barrel 120 is tilted to the left of the optical axis C1 as seen from FIG. 12A, then the other end 340 of the actuator unit 130 may be moved to the right with the housing 110 fixed so that the two optical axes C1 and C2 are aligned with each other. In contrast, if the optical axis C2 of the lens barrel 120 is tilted to the right of the optical axis C1 as seen from FIG. 12B, then the other end 340 of the actuator unit 130 may be moved to the left with the housing 110 being fixed so that the two optical axes C1 and C2 are aligned with each other. Here, the housing 110 may be fixed by a first jig (not shown) which is able to hold the housing 110, and the actuator unit 130 may be moved by a second jig 400 which is movable in the direction of alignment of the actuator 200. The second jig 400 may be coupled to the adjustment portion 340.

After the active alignment of the lens barrel 120 is completed, the other end 340 of the actuator unit 130 may be fixed. The fixing of the other end 340 may be made by adhesion, bolt coupling or the like. However, the fixing of the other end 340 is not limited to the above manner, but may be changed as necessary.

Next, a lens module 100 according to another embodiment of the present invention will be described with reference to FIG. 13.

The lens module 100 according to the embodiment may further include a shield can 150. The shield can 150 may cover the top and side surfaces of the housing 110, to block harmful electromagnetic waves from being emitted therefrom. Further, the shield can 150 may have a structure in which the active alignment of the lens barrel 120 may be made. For example, the shield can 150 may have an alignment hole 152 through which the other end (i.e., the adjustment portion 340) of the actuator unit 130 is exposed so that the other end of the actuator unit 130 can be moved.

The shield can 150 may have one or more alignment holes 154 formed on its side surfaces. The alignment holes 154 may reach the actuator unit 130. Accordingly, sometimes the active alignment of the lens barrel 120 may be made by moving the actuator unit 130 through the alignment holes 154. A reference numeral 156 denotes a hole through which light reflected on a subject is incident onto the lens barrel 120.

Next, a lens module 100 according to another embodiment of the present invention will be described with reference to FIGS. 14 and 15.

In this embodiment, the lens module 100 may have a structure in which the housing 110 may be moved relative to the image sensor unit 140. To this end, a protrusion member 119 for coupling with the image sensor unit 140 may be formed on one end of the housing 110, and a coupling portion 146 in which the protrusion member 119 is fitted may be formed on one surface of the image sensor unit 140.

As shown in FIG. 15, in the lens module 100 thus configured, the active alignment may be made in the same or a similar manner as described above, with one end of the housing 110 fixed to the image sensor unit 140. Then, after the active alignment is completed, an adhesive, bolt or pin may be inserted between the housing 110 and the image sensor unit 140 so that the position of the housing 110 relative to the image sensor unit 140 may be fixed.

In the embodiment, although the protrusion members 350 and 119 are formed on one end of the bracket 300 or the housing 110, and the coupling portions 116 and 146 are formed in the housing 110 or the image sensor unit 140 coupling with the protrusion member 350 and 119, the positions of the protrusion members and the coupling portions may be switched. For example, a hole-like coupling portion may be formed in one end of the bracket 300 or the housing 110, and a protrusion member may be formed on the corresponding housing 110 or the image sensor unit 140.

In the following, a method of manufacturing a lens module according to an embodiment will be described.

The manufacturing method according to the embodiment may include the steps of: coupling a lens barrel with an actuator unit; mounting the lens barrel and the actuator unit; comparing the optical axis of the lens barrel with the optical axis of an image sensor unit; performing active alignment of the lens barrel; and fixing the actuator unit. The manufacturing method may further include a step of mounting a shield can.

1) Coupling Lens Barrel to Actuator Unit

In this operation, a lens barrel 120 may be coupled to an actuator unit 130. Specifically, the actuator unit 130 which moves the lens barrel 120 accommodating one or more lenses in a direction, such as the alignment direction, may be mounted in the lens barrel 120. Here, the actuator unit 130 may include a smooth impact drive mechanism (SIDM) actuator.

2) Mounting Lens Barrel and Actuator Unit

In this operation, the assembly of the lens barrel 120 and the actuator unit 130 may be mounted in a housing 110. In addition, this operation may include coupling or fixing one end of the actuator unit 130 to the housing 110. Here, the lens barrel 120 may be mounted in the housing 110 without any contact with the housing 110. Further, the actuator unit 130 may be mounted in the housing 110 with its one end fixed to the housing 110 and the other end not fixed to the housing 110.

3) Comparing Optical Axis of Lens Barrel with Optical Axis of Image Sensor Unit

In this operation, it may be determined whether or not the optical axis C2 of the lens barrel 120 is aligned with the optical axis C1 of the image sensor 142. In addition, in this operation, it may be determined whether the lens module 100 is positive or negative based on whether the optical axes are aligned with each other or not. If two optical axes C1 and C2 are aligned with each other, the proceeding to operation 5 is in order). Otherwise, the difference between the optical axes C1 and C2 may be measured. Here, the measured value may be delivered to active alignment units of the lens barrel 120.

4) Performing Active Alignment of Lens Barrel

In this operation, the tilt of the lens barrel may be aligned (i.e., actively aligned). The active alignment may be made by moving the other end of the actuator unit 130 using a second jig 400 with the housing 110 fixed to a first jig. However, the active alignment is not limited thereto, but may be made by moving other parts than the other end of the actuator unit 130, as necessary. For example, the active alignment of the lens barrel 120 may be made by moving the side surfaces of the lens barrel 120 or the actuator unit 130. In this regard, the first and second jigs may be one integrated jig device.

5) Fixing Actuator Unit

In this operation, the other end of the actuator unit 130 may be fixed. That is, while the active alignment is available, the position of the actuator unit 130 may be changed, and accordingly the actively-aligned position of the lens barrel 120 may be changed. After actively aligning the position of the lens barrel 120, the other end of the actuator unit 130 may be fixed so that the position of the actively-aligned lens barrel 120 is not changed.

In this connection, the other end of the actuator unit 130 may be fixed by adhesion, e.g., by inserting an adhesive or by coupling, e.g., using a bolt or pin.

The lens module 100 manufactured as described above may actively align the lens barrel 120 with the lens barrel 120 mounted in the housing 110, so that the production yield of the lens module 100 may be increased.

In addition, in the manufacturing method of a lens module according to the embodiment, the active alignment of the lens barrel 120 is made with one end of the actuator unit fixed, so that automation of the active alignment operation can be easy and the precision of the active alignment can be improved.

As set forth above, according to some embodiments, for example, but not limited to, a tilt of a lens barrel can be adjusted while being mounted in the housing, thereby improving the assembly precision of the lens barrel with respect to an image sensor. Accordingly, the resolution of a lens module can be improved, and faulty images caused by a tilt of a lens barrel can be significantly reduced.

Further, a lens barrel can be moved in a direction orthogonal to an optical axis with a simple operation, thereby reducing the time and process necessary for the active alignment of the lens barrel.

While the present invention has been shown and described in connection with the embodiments, it will be apparent to those skilled in the art that modifications and variations can be made without departing from the spirit and scope of the invention as defined by the appended claims. Accordingly, the illustrative discussions above are not intended to be exhaustive or to limit the invention to the precise forms disclosed.

What is claimed is:

1. A lens module, comprising:
a housing;
a lens barrel mounted in the housing; and
an actuator unit including an actuator to move the lens barrel,
wherein the actuator unit has a coupling area on one end for coupling with the housing, and an adjustment portion on another end for adjusting a tilt of the lens barrel.

2. The lens module of claim 1, wherein the adjustment portion comprises a groove.

3. The lens module of claim 1, wherein the actuator unit has a hole through which an adhesive for bonding the actuator unit and the housing is injected.

4. The lens module of claim 1, further comprising an affixation member for fixing the actuator unit to the housing.

5. The lens module of claim 1, wherein:
the actuator unit has one or more holes formed in the another end, and
the housing has one or more protrusions, each protrusion having a size smaller than that of a respective hole.

6. The lens module of claim 1, wherein the actuator includes:
a rod member;
a piezoelectric member coupled to the rod member and configured to generate a vibration; and
a mass member coupled to the piezoelectric member and having a predetermined mass.

7. The lens module of claim 6, wherein the rod member is in contact with a magnetic material mounted on the lens barrel.

8. The lens module of claim 1, wherein the actuator unit includes a bracket for accommodating the actuator, and
wherein the actuator comprises:
a rod member in contact with the lens barrel,
a piezoelectric member coupled to the rod member and configured to generate a vibration, and
a mass member coupled to the piezoelectric member and having a predetermined mass.

9. The lens module of claim 1, wherein one or more adjustment holes through which the adjustment portion is exposed to the outside of the housing are formed in one or more surfaces of the housing.

10. The lens module of claim 1, wherein:
the coupling area has a protrusion member extending in a direction of an optical axis of the lens barrel, and
the housing has a coupling portion in which the protrusion member is fitted.

11. The lens module of claim 1, wherein:
the coupling area has a protrusion member extending in a direction of an optical axis of the lens barrel, and
a cross-section of the protrusion member has a hemispherical, pyramidal or conical shape.

12. The lens module of claim 1, wherein the coupling area and the adjustment portion are arranged in a collinear manner.

13. A lens module, comprising:
a housing;
an image sensor unit mounted in the housing;
a lens barrel mounted in the housing; and
an actuator unit including an actuator to move the lens barrel,
wherein:
a coupling area for coupling to the image sensor unit is formed on one end of the actuator unit, and
an adjustment portion for adjusting a tilt of the lens barrel is formed on another end of the actuator unit.

14. The lens module of claim 13, wherein the actuator includes:
a rod member;
a piezoelectric member coupled to the rod member and configured to generate a vibration; and
a mass member coupled to the piezoelectric member and having a predetermined mass.

15. The lens module of claim 14, wherein the rod member is in contact with a magnetic material mounted on the lens barrel.

16. The lens module of claim 13, wherein the actuator unit includes a bracket accommodating the actuator, the actuator including a piezoelectric member.

17. The lens module of claim 13, wherein:
the coupling area comprises a protrusion member extending in a direction of an optical axis of the lens barrel, and
the image sensor unit has a coupling portion in which the protrusion member is fitted.

18. The lens module of claim 13, wherein the coupling area and the adjustment portion are arranged in a collinear manner.

19. A lens module, comprising:
a housing;
a lens barrel mounted in the housing; and
an actuator unit including an actuator to move the lens barrel, one end of the actuator unit being fixed to the housing;
wherein the housing has an alignment hole through which a part of the actuator unit or the lens barrel is exposed so that a tilt of the actuator unit or the lens barrel can be adjusted.

20. A lens module, comprising:
a housing;
a lens barrel mounted in the housing;
an actuator unit including an actuator to move the lens barrel, one end of the actuator unit being fixed to the housing; and
a fixing unit fixing the actuator unit to the housing with a tilt of the lens barrel adjusted.

21. The lens module of claim 20, wherein the fixing unit comprises an adhesive or a bolt.

22. The lens module of claim 20, wherein the housing has one or more surfaces defining therein one or more holes for mounting the fixing unit.

23. The lens module of claim 20, wherein the actuator includes a piezoelectric member.

24. The lens module of claim 20, wherein the fixing unit is coupled to the actuator unit.

25. A lens module, comprising:
an image sensor unit having an image sensor mounted thereon;
a housing including a lens barrel and an actuator to move the lens barrel, wherein a coupling area for coupling to the image sensor unit is formed on one end of the housing, and an adjustment portion for adjusting a tilt of the housing relative to the image sensor is formed on another end of the housing; and
a fixing unit coupling the image sensor unit to the housing, with the tilt of the housing relative to the image sensor adjusted.

26. A method of manufacturing a lens module, comprising:
fixing one end of an actuator coupled to a lens barrel to a housing;
aligning the lens barrel by moving another end of the actuator in an orthogonal direction to an optical direction of the lens barrel; and
fixing another end of the actuator to the housing.

27. The method of claim 26, wherein the aligning the lens barrel comprises adjusting a tilt of the lens barrel by moving an end of the actuator unit with the housing fixed.

28. The method of claim 26, wherein the fixing of the another end of the actuator to the housing includes injecting an adhesive into a contact portion between the another end of the actuator and the housing.

29. The method of claim 26, wherein the fixing of the another end of the actuator to the housing includes coupling the another end of the actuator unit with the housing by using a coupler.

30. The method of claim 26, wherein the aligning the lens barrel includes:
fixing the housing to a first jig; and
moving the another end of the actuator to a second jig which is movable relative to the first jig.

31. An apparatus for adjusting a tilt of a lens barrel, comprising:
an actuator configured to move a lens barrel assembled in a housing, the actuator comprising:
a coupling area coupled to the housing; and
a movable portion to adjust a tilt of the assembled lens barrel.

32. The apparatus of claim 31, wherein:
the coupling area is formed on one end of the actuator; and
the movable portion is formed on another end of the actuator.

33. The apparatus of claim 31, wherein the movable portion is movable in a direction orthogonal to an optical axis of the lens barrel.

34. The apparatus of claim 31, further comprising a fixer to fix the movable portion to the housing after adjusting the tilt of the assembled lens barrel.

35. The apparatus of claim 34, wherein the actuator has one or more holes for inserting the fixer therethrough.

36. The apparatus of claim 31, wherein the movable portion has a portion with a shape for coupling with a tool for carrying out alignment of the assembled lens barrel.

37. The apparatus of claim 31, wherein the coupling area has a hole or protrusion to couple with the housing.

38. The apparatus of claim 31, wherein the actuator further comprises a rod shaped member interacting with a magnetic material mounted on the lens barrel.

39. The apparatus of claim 31, wherein the housing comprises one or more holes to expose the movable portion of the actuator to outside of the housing.

40. The apparatus of claim 31, wherein the coupling area of the actuator is fixed to the housing so that the lens barrel does not contact with the housing.

41. The apparatus of claim 31, wherein the actuator is mounted near an edge of the housing.

42. The apparatus of claim 31, wherein the tilt of the lens barrel is adjusted to align an optical axis of the lens barrel with an optical axis of an image sensor.

43. The apparatus of claim 31, wherein the actuator comprises a vibrator configured to generate a force to move the lens barrel.

44. An apparatus for adjusting a tilt of a lens barrel, comprising:
an actuator configured to move a lens barrel assembled in a housing, the actuator comprising:
a coupling area coupled to an image sensing unit comprising an image sensor; and
a movable portion for adjusting a tilt of the assembled lens barrel.

45. The apparatus of claim 44, wherein:
the coupling area is formed on one end of the actuator; and
the movable portion is formed on another end of the actuator.

46. The apparatus of claim 44, wherein the movable portion is movable in a direction orthogonal to an optical axis of the lens barrel.

47. The apparatus of claim 44, further comprising a fixer to fix the movable portion to the housing after adjusting the tilt of the assembled lens barrel.

48. The apparatus of claim 44, wherein the coupling area has a hole or protrusion to couple with the image sensing unit.

49. The apparatus of claim 44, wherein the tilt of the lens barrel is adjusted to align an optical axis of the lens barrel with an optical axis of the image sensor.

50. The apparatus of claim 44, wherein the movable portion has a portion with a shape for coupling with a tool for carrying out alignment of the assembled lens barrel.

51. The apparatus of claim 44, wherein the housing comprises one or more holes to expose the movable portion of the outside of the housing.

52. A method for manufacturing a lens module, comprising:
assembling a lens module comprising a housing, a lens barrel and an actuator coupled to the lens barrel;
moving a movable portion of the actuator to adjust a tilt of the assembled lens barrel after the assembling the lens module; and
fixing the movable portion of the actuator to the housing.

53. The method of claim 52, wherein the assembling the lens module comprises fixing one end of the actuator to the housing.

54. The method of claim 52, wherein the assembling the lens module comprises fixing one end of the actuator to an image sensing unit comprising an image sensor.

55. The method of claim 52, wherein the moving the movable portion of the actuator comprises aligning an optical axis of the lens barrel with an optical axis of an image sensor.

56. The method of claim 52, wherein the moving the movable portion of the actuator comprises coupling the movable portion of the actuator with a tool for carrying out active alignment of the tilt of the assembled lens barrel.
